(19) United States
(12) Patent Application Publication
(10) Pub. No.: US 2017/0325460 A1
(43) Pub. Date: Nov. 16, 2017

(54) STABLE AQUEOUS HERBICIDAL COMPOSITIONS

(71) Applicant: PBI-Gordon Corporation, Kansas City, MO (US)

(72) Inventors: Dale R. Sanson, Kearney, MO (US); Jeffrey W. Marvin, Overland Park, KS (US); Barry Glover, Baldwin City, KS (US)

(21) Appl. No.: 15/592,711

(22) Filed: May 11, 2017

Related U.S. Application Data
(60) Provisional application No. 62/335,387, filed on May 12, 2016.

(51) Int. Cl. A01N 57/20; A01N 37/34; A01N 25/04

(52) U.S. Cl. CPC A01N 57/20; A01N 25/04; A01N 37/34

(57) ABSTRACT

Stable, aqueous herbicidal compositions are provided which comprise both glyphosate and dichlobenil dispersed in water. The stable formulations utilize one or more nonionic surfactants that interact with the coating of encapsulated dichlobenil in order to provide chemical stability in the aqueous composition. The compositions may be provided as a concentrate or ready-to-use formulation. Advantageously, compositions of the present invention are both physically and chemically stable when stored for prolonged periods in both ambient and extreme temperature. Additionally, the inventive compositions are capable of providing improved control of undesired vegetation by controlling both adult plants and seedlings.

### CROSS-REFERENCE TO RELATED APPLICATION

This application claims the benefit of U.S. Provisional Patent Application No. 62/335,387, filed May 12, 2016, which is incorporated by reference herein in its entirety.

### BACKGROUND OF THE INVENTION

### Field of the Invention

The present invention is directed to stable aqueous herbicidal compositions comprising both glyphosate and dichlobenil.

### Description of the Prior Art

Glyphosate is a water soluble herbicidal compound commonly applied to undesired adult plants that compete with crops, such as annual broadleaf weeds and grasses. Although a generally chemically stable compound in aqueous solutions, it is often a challenge to mix glyphosate with other herbicides in solution due to issues with physical stability. Dichlobenil is a water-insoluble herbicidal compound that is useful in controlling (or preventing) the growth of seeds and seedlings of undesired plants. In contrast to glyphosate, dichlobenil is generally physically stable but often presents challenges in aqueous mixtures because water hydrolyzes the dichlobenil molecule. Due to the differences in solubility and stability, any efforts to combine these compounds into an aqueous herbicidal composition have been largely unsuccessful. Therefore, there is a need in the art for systems and methods capable of successfully combining glyphosate and dichlobenil to provide improved all-around herbicidal control compositions.

### SUMMARY OF THE INVENTION

In one embodiment of the present invention, there is provided an aqueous herbicidal concentrate composition. The concentrate composition comprises glyphosate, dichlobenil, and a nonionic surfactant dispersed in water. The concentration may be diluted in about 8 to about 30 parts by weight of water to form an herbicidal use solution.

In another embodiment, there is provided an aqueous ready-to-use herbicidal composition. The ready-to-use composition comprises glyphosate, dichlobenil, and a nonionic surfactant dispersed in water. The ready-to-use composition is formulated for application to vegetation without being further diluted.

In yet another embodiment, there is provided a method of controlling undesired vegetation. The method comprises applying to the locus of the undesired vegetation, an herbicidally effective amount of an aqueous herbicidal composition. The composition comprises glyphosate, dichlobenil, and a nonionic surfactant dispersed in water.

In still another embodiment, there is provided a method of formulating an herbicidal composition. The method comprises mixing glyphosate, dichlobenil, and a nonionic surfactant in water to form an aqueous mixture. The composition can be in the form of a concentrate that is capable of being diluted to form a use solution, or the composition can be prepared as a ready-to-use formulation.

### DETAILED DESCRIPTION OF THE PREFERRED EMBODIMENTS

Embodiments of the present invention are directed to aqueous herbicidal compositions comprising glyphosate, dichlobenil, and a nonionic surfactant dispersed in water. As used herein, the term “dispersed” can mean any of dissolved, dispersed, or suspended. In certain embodiments, the herbicidal compositions are stable concentrate compositions, which are diluted with water shortly before use. In certain other embodiments, the herbicidal compositions are stable, ready-to-use compositions, which may be used without dilution. Compositions and methods in accordance with embodiments of the present invention advantageously provide an herbicidally effective amount of glyphosate and dichlobenil in a stable aqueous formulation. As used herein, the term “herbicidally effective amount” refers to the amount of a specific component or mixture of components sufficient to exterminate, impair, prevent, and/or suppress the growth of undesired vegetation.

Aqueous compositions in accordance with embodiments of the present invention include glyphosate dispersed in water. Glyphosate is a non-selective, water-soluble herbicide, also known in its acid form as N-(phosphonomethyl)glycine. As used herein, the term “glyphosate” encompasses not only glyphosate acid but also salts, adducts and esters (and/or other derivatives known in the art) thereof, and compounds which can be converted to glyphosate in plant tissues or which otherwise provide glyphosate ions. Glyphosate is generally known as a strong electrolyte, which will completely (or almost completely) ionize or dissociate in an aqueous solution. In preferred embodiments, the glyphosate is present as a water-soluble salt. For example, in certain embodiments glyphosate may be present as a glyphosate salt such as an alkali metal salt (e.g., sodium or potassium salt), an ammonium salt, an alkylamine or a C1-6 alkylammonium salt (e.g., dimethylammonium or isopropylammonium salt), a C1-6 alkanolammonium salt (e.g., monoethanolammonium salt), a C1-6 alkylsulfonium salt (e.g., trimethylsulfonium salt), and mixtures thereof. Moreover, as the N-(phosphonomethyl)glycine molecule has three acid sites having different pKa values, mono-, di-, and tribasic salts, or any mixture thereof, or salts of any intermediate level of neutralization, can also be used. It should be understood that the above list of salts is non-exhaustive, and other known herbicidally-effective glyphosate salts and derivatives may be used in embodiments of the present invention. In certain preferred embodiments, the composition comprises a glyphosate salt, wherein the glyphosate salt is a glyphosate isopropyl amine (isopropylammonium).

Aqueous compositions in accordance with embodiments of the present invention further include dichlobenil. Dichlobenil, also known as 2,6-dichlorobenzonitrile or DCBN, is a generally water-insoluble herbicide effective for killing young seedlings of both monocot and dicot species. In contrast to glyphosate, which is particularly effective against mature plants, dichlobenil is a powerful inhibitor of plant germination due to its interference with cellulose synthesis. In certain embodiments, the dichlobenil is provided in the compositions as a liquid suspension product comprising encapsulated (or microencapsulated) dichlobenil particles. As used herein, the term “encapsulated” generally refers to particles or droplets surrounded and/or protected by a coating (such as by a surfactant coating), unless otherwise specified. In certain embodiments, the encapsulating material is a polymer membrane and/or resinous coating, which encapsulates solid dichlobenil crystals or particles. For example, the encapsulated dichlobenil may be provided as dual-coated encapsulated particles having an inner coacervated coating and an outer melamine-urea-resin polymer coating. The encapsulated dichlobenil particles may be provided in a liquid suspension formulation comprising the encapsulated particles and a thickening agent (e.g., xanthan gum and/or succinoglycan gum). In certain embodiments, the encapsulated dichlobenil particles will have a volume-average particle size (Dᵥ) of about 2 μm to about 10 μm, preferably about 4 μm to about 8 μm, and more preferably about 5 μm to about 7 μm. Exemplary methods of forming liquid suspensions comprising microencapsulated dichlobenil, are described in U.S. Pat. No. 7,718,572, incorporated by reference herein in its entirety.

Dichlobenil is generally unstable in aqueous compositions and is difficult to mix with other herbicides. Moreover, glyphosate is a strong electrolyte, which can destabilize typical coating materials protecting dichlobenil from hydrolysis in aqueous solutions. It has been discovered that the use of one or more inert components in aqueous compositions can advantageously provide stable aqueous formulations comprising both glyphosate and dichlobenil. Without being bound by any theory, it is believed that the encapsulation material surrounding the dichlobenil interacts in solution with certain inert components in such a manner that renders the encapsulated dichlobenil chemically and physically stable in aqueous mixtures, including aqueous mixtures comprising strong electrolytes (e.g., glyphosate). Therefore, the selection of preferred inert components can prevent degradation of the encapsulated dichlobenil coating by the strong electrolyte. This allows an herbicidally effective amount of encapsulated dichlobenil to be successfully incorporated into aqueous systems comprising an herbicidally effective amount of glyphosate without hydrolysis of the dichlobenil active ingredient.

In preferred embodiments, the one or more inert components comprises a nonionic surfactant. In certain embodiments, the nonionic surfactant comprises a polymer selected from the group consisting of acrylic copolymers, block copolymers, comb polymers, star-shaped polymers, ethoxylated alcohols, and mixtures thereof. In certain preferred embodiments, for example, the nonionic surfactant comprises a polymethyl methacrylate-polyethylene glycol graft copolymer, such as Atlox 4913 available from Croda Crop Care. It is within the scope of the present invention, however, that many other nonionic surfactants may be used as long as they effectively interact with the encapsulated dichlobenil so as to protect the active dichlobenil in stable aqueous compositions. For example, in some embodiments, the nonionic surfactant may be a long chain alcohol such as fatty alcohols, cetyl alcohol, stearyl alcohol, cetostearyl alcohol, or oleyl alcohol, polyoxyethylene glycol alkyl ethers, octaethylene glycol monododecyl ether, pentaethylene glycol monododecyl ether, polyoxypropylene glycol alkyl ethers, glucoside alkyl ethers, decyl glucoside, lauryl glucoside, octyl glucoside, polyoxyethylene glycol octylphenol ethers, polyoxyethylene glycol alkylphenol ethers, nonoxynols, glycerol alkyl esters, glyceryl laurate, polyoxyethylene glycol sorbitan alkyl esters, sorbitan alkyl esters, cocamide MEA, cocamide DEA, dodecyldimethylamine oxide, block copolymers of polyethylene glycol and polypropylene glycol (poloxamers), polyethoxylated tallow amine (POEA), and mixtures thereof.

The compositions may also comprise a number of other components that are included to improve herbicidal effectiveness, to improve chemical and/or physical stability, or to provide other desirable properties to the compositions. However, in certain embodiments, the present invention comprises a system of herbicidally effective active ingredients. In such certain embodiments, the system of herbicidally effective active ingredients comprises, consists of, or consists essentially of glyphosate, dichlobenil, and a nonionic surfactant dispersed in water.

Other preferred inert components include an antifreeze agent and/or a gelling or thickening agent (i.e., “swelling clay”). In preferred embodiments, the antifreeze agent is a branched or linear glycol selected from the group consisting of propylene glycol, hexylene glycol, glycerin, and mixtures thereof. In preferred embodiments, the gelling or thickening agent is an inert, powdered attapulgite (magnesium aluminium phyllosilicate) such as Attagel® 50 available from BASF.

In certain embodiments, additional nonionic surfactants (other than the surfactant used for stabilizing the encapsulated dichlobenil, described above) may be present in order to increase the herbicidal activity of the formulations. Such additional nonionic surfactants may include linear or branched alcohols with ethoxylation ranging from 5 to 12 moles. For example, in certain preferred embodiments, the composition may comprise an additional nonionic surfactant comprising a poly (5, 7, or 9) oxyethylene C₁₁ alcohol. In certain other embodiments, the nonionic ethoxylated alcohol surfactants may be used as the stabilizing surfactant, and no other surfactant is necessary.

Additional components that may be present in compositions prepared in accordance with embodiments of the present invention include antifoaming agents, antimicrobial agents (e.g., an aqueous microbiocide), thickeners (e.g., xantham gum), pH adjusting agents (e.g., citric acid or sodium hydroxide), and/or stabilizers (e.g., dimethylamine). It is noted that certain embodiments of the present invention comprise only nonionic surfactants in order to maintain physical and chemical stability of the compositions, as cationic and anionic surfactants could destabilize the encapsulating material and/or hydrolyze the dichlobenil in aqueous solutions. Therefore, in such embodiments, the use of cationic and anionic surfactants, especially separately-added cationic and anionic surfactants, are avoided. It is noted that trace amounts of one or more of these surfactants may be present due to their use in the preparation of the encapsulated dichlobenil. However, in preferred embodiments, the compositions are substantially free of cationic and anionic surfactants. As used herein, the term “substantially free” is defined as having less than 0.1% by weight, preferably less than 0.01% by weight, and more preferably less than 0.001% by weight of a particular component based upon the total weight of the composition.

The formulations of the present invention are generally formulated by mixing glyphosate or a salt thereof, dichlobenil (e.g., encapsulated dichlobenil), and a nonionic surfactant in water to form an aqueous mixture. In certain embodiments, about 0.01 lbs/gal to about 0.70 lbs/gal of active dichlobenil (or about 0.05 lbs/gal to about 7.0 lbs/gal of encapsulated dichlobenil suspension product) is mixed with about 0.007 lbs/gal to about 0.40 lbs/gal of active glyphosate, although other concentrations may be used within the scope of the present invention. The other components described above may similarly be added to and mixed in the aqueous solution. The components can be mixed in water using, for example, a pump shear, although other methods of mixing are also within the scope of the invention. The aqueous mixture may be prepared by adding each component to water individually or by forming separate aqueous solutions of dichlobenil and glyphosate and subsequently mixing the separate solutions. In certain preferred embodiments, the dichlobenil is provided as a commercially-available encapsulated dichlobenil liquid suspension product. In certain preferred embodiments where the composition is provided as a concentrate formulation, the weight ratio of nonionic surfactant to dichlobenil (active dichlobenil) is from about 1:5 to about 5:1, preferably from about 1:4 to about 4:1, and more preferably from about 1:3 to about 3:1. In other preferred embodiments where the composition is provided as a ready-to-use formulation, the weight ratio of nonionic surfactant to dichlobenil (active dichlobenil) is from about 1:2 to about 20:1, preferably from about 1:1 to about 15:1, and more preferably from about 2:1 to about 10:1.

In certain embodiments, the formulations are prepared as chemically and physically stable concentrate compositions. The following table provides ranges for certain components (% active ingredient) present in particular concentrate formulations in accordance with one embodiment of the present invention.

| | Broad range | Intermediate range | Narrow range |
|---|---|---|---|
| Component | (wt. %) | (wt. %) | (wt. %) |
| Glyphosate (active) | 0.1-10.0% | 0.3-8.0% | 0.7-6.0% |
| Dichlobenil (active) | 0.1-15.0% | 0.5-10.0% | 0.8-8.0% |
| Nonionic surfactant | 0.5-10.0% | 1.0-8.0% | 1.5-5.0% |
| Antifreeze agent | 1.0-10.0% | 3.0-8.0% | 4.0-7.0% |
| Antifoaming agent | 0-3.0% | .01-2.0% | 0.05-1.5% |
| Antimicrobial agent | 0-1.0% | 0.1-0.8% | 0.3-0.5% |
| Thickener | 0.2-5.0% | 0.5-3.0% | 0.8-2.5% |
| pH adjusting agent | As needed | As needed | As needed |
| Stabilizers | 0-1.0% | 0.01-0.8% | 0.05-0.6% |
| Water | 50-92% | 60-90% | 70-88% |

In embodiments, the concentrate compositions are storage stable for at least 3 months at 25° C., preferably at least 6 months at 25° C., and more preferably at least about one year at 25° C. As used herein, the term “storage stable” means that the aqueous mixture components do not precipitate (physically stable) or chemically degrade (chemically stable) over the specified time period. The concentrate compositions have a pH between about 5 and about 8, preferably between about 5.5 and about 7.5, and more preferably about 6 and about 7. The pH of the concentrate composition may be adjusted by adding an appropriate amount of acidic or basic pH adjusting agent. Prior to application by the consumer, the concentrate composition is diluted with water to form an herbicidal use composition comprising one part by weight of the concentrate diluted in about 8 to about 30 parts by weight of water, preferably about 9 to about 20 parts by weight of water, and even more preferably about 10 to about 15 parts by weight of water.

In other embodiments, the formulations are prepared as chemically and physically stable ready-to-use compositions. The following table provides ranges for certain components (% active ingredient) present in particular ready-to-use formulations in accordance with one embodiment of the present invention.

| | | Intermediate | |
|---|---|---|---|
| | Broad range | range | Narrow range |
| Component | (wt. %) | (wt. %) | (wt. %) |
| Glyphosate (active) | 0.01-8.0% | 0.05-6.0% | 0.1-4.0% |
| Dichlobenil (active) | 0.01-6.0% | 0.1-4.0% | 0.2-3.0% |
| Nonionic surfactant | 0.5-10.0% | 1.0-8.0% | 1.5-5.0% |
| Antifreeze agent | 1.0-10.0% | 3.0-8.0% | 4.0-7.0% |
| Antifoaming agent | 0-3.0% | .01-2.0% | 0.05-1.5% |
| Antimicrobial agent | 0-1.0% | 0.1-0.8% | 0.3-0.5% |
| Thickener | 0.2-5.0% | 0.5-3.0% | 0.8-2.5% |
| pH adjusting agent | As needed | As needed | As needed |
| Stabilizers | 0-1.0% | 0.01-0.8% | 0.05-0.6% |
| Water | 80-96% | 85-94% | 88-92% |

The ready-to-use compositions are storage stable for at least 3 months at 25° C., preferably at least 6 months at 25° C., and more preferably at least about one year at 25° C. The ready-to-use compositions have a pH between about 5 and about 8, preferably between about 5.5 and about 7.5, and more preferably about 6 and about 7. The pH of the composition may be adjusted by adding an appropriate amount of acidic or basic pH adjusting agent. Unlike the concentrate compositions, however, these compositions are ready-to-use without dilution.

Methods of controlling undesired vegetation comprise applying an herbicidally effective amount of an aqueous herbicidal composition, such as a diluted concentrate (use) composition or ready-to-use composition described above, to the locus of the undesired vegetation. In either form, the herbicidal composition may be applied using known methods for applying liquid herbicides. For example, the herbicidal compositions of the present invention may be sprayed onto a plot of land containing the undesired vegetation using a spray mechanism calibrated to the appropriate application rate. In certain embodiments, the aqueous herbicidal composition is applied to the locus of the undesired vegetation at an amount sufficient to supply from about 0.01 to about 0.5 pounds per acre, preferably from about 0.05 to about 0.3 pounds per acre, and more preferably from about 0.1 to about 0.2 pounds per acre of said glyphosate and from about 0.01 to about 0.5 pounds per acre, preferably from about 0.05 to about 0.3 pounds per acre, and more preferably from about 0.1 to about 0.2 pounds per acre of said dichlobenil.

Herbicidal compositions and methods in accordance with the present invention are advantageously capable of controlling both seedling and adult plants, thereby providing improved control of undesired vegetation over long periods of time. For example, the compositions and methods of the present invention are effective in controlling undesired vegetation such as seedling and adult (both annual and perennial) grasses, flowering plants (including sedges), weeds (including broad-leaved weeds), and woody plants. In certain embodiments, the compositions and methods achieve at least about 80% vegetation control, preferably at least about 90% vegetation control, and more preferably at least about 95% vegetation control, after 14 days. As used herein, “% vegetation control” includes the killing of germinated plants, and/or the prevention of seed germination within a defined area of ground during a designated time period as determined by visual observation.

### EXAMPLES

The following examples set forth exemplary formulations, as well as stability and vegetation control data of formulations prepared in accordance with certain embodiments of the present invention. It is to be understood, however, that these examples are provided by way of illustration and nothing therein should be taken as a limitation upon the overall scope of the invention. In the examples below, the following commercially-available products are used:
Casoron® CS by Chemtura, encapsulated dichlobenil product with a label rate of 15.3% active dichlobenil;
Casoron® 170CS by Chemtura, encapsulated dichlobenil product with a label rate of 15.0% active dichlobenil;
Glyphosate Isopropyl Amine (IPA), salt product with a label rate of 62.5% active glyphosate;
Atlox™ 4913 by Croda, polymeric surfactant and dispersant;
Tomadol® 1-7 by Air Products and Chemicals, nonionic alcohol ethoxylate surfactant;
Attagel® 50 by BASF, inert suspending agent;
Keltrol® BT by CP Kelco, xanthan gum thickening agent;
Propylene Glycol, anti-freeze agent;
Harcros® 8810 IND by Harcros Chemicals, industrial grade antifoaming agent;
NaOH solution, pH adjuster;
Acticide® 20 by THOR Specialties, biocide; and
Proxel™ GXL, broad spectrum biocide.

### Example I

Exemplary compositions were prepared, with the component amounts provided in the table(s) below. A first composition was prepared for toxicology testing by the EPA having relatively high concentrations of active ingredients.

TABLE 1
Formulation 1: composition prepared for EPA toxicology testing.

| | | | | | Prep | |
|---|---|---|---|---|---|---|
| | | Mass | Mass | Vol | Mass | Prep |
| Ingredient | Purity | (g) | (lb) | (gal) | (g) | Wt % |
| Casoron CS | 15.3% | 495.2 | 1.091 | 0.118 | 297.1 | 49.52% |
| Glyphosate IPA | 62.5% | 87.2 | 0.192 | 0.020 | 52.3 | 8.72% |
| Atlox 4913 | 100.0% | 15.70 | 0.035 | 0.004 | 9.4 | 1.57% |
| Tomadol 1-7 | 100.0% | 20.9 | 0.046 | 0.006 | 12.5 | 2.09% |
| Attagel 50 | 100.0% | 20.2 | 0.044 | 0.003 | 12.1 | 2.02% |
| Keltrol BT | 100.0% | 1.6 | 0.004 | 0.000 | 1.0 | 0.16% |
| Propylene Glycol | 100.0% | 52.0 | 0.115 | 0.013 | 31.2 | 5.20% |
| Harcros 8810 | 100.0% | 0.8 | 0.002 | 0.000 | 0.5 | 0.08% |
| IND | | | | | | |
| Isopropylamine | 99.0% | 11.7 | 0.026 | 0.003 | 7.0 | 1.17% |
| Acticide B20 | 100.0% | 4.2 | 0.009 | 0.001 | 2.5 | 0.42% |
| DI Water | 100% | 290.5 | 0.640 | 0.077 | 174.3 | 29.05% |
| Totals | | 1000.0 | 2.203 | 0.246 | 600.0 | 100.00% |

| Label | Active Ingredient % | lbs/gal |
|---|---|---|
| Dichlobenil | 7.58% | 0.682 |
| Glyphosate | 5.45% | 0.491 |

| | |
|---|---|
| Theoretical Density = | 9.00 lbs/gal |
| pH = | {6.2-6.8} |

A number of additional concentrate and ready-to-use compositions were prepared as provided in the tables below. The ready-to-use compositions do not need to be diluted with water prior to application to undesired vegetation.

TABLE 2
Formulation 2: concentrate composition.

| | | | | | Prep | |
|---|---|---|---|---|---|---|
| | | Mass | Mass | Vol | Mass | Prep |
| Ingredient | Purity | (g) | (lb) | (gal) | (g) | Wt % |
| Casoron CS | 15.3% | 54.7 | 0.120 | 0.013 | 32.8 | 5.47% |
| Glyphosate IPA | 62.5% | 11.8 | 0.026 | 0.003 | 7.1 | 1.18% |
| Atlox 4913 | 100.0% | 3.20 | 0.007 | 0.001 | 1.9 | 0.32% |
| Tomadol 1-7 | 100.0% | 19.5 | 0.043 | 0.005 | 11.7 | 1.95% |
| Attagel 50 | 100.0% | 15.0 | 0.033 | 0.002 | 9.0 | 1.50% |
| Keltrol BT | 100.0% | 3.2 | 0.007 | 0.000 | 1.9 | 0.32% |
| Propylene Glycol | 100.0% | 50.0 | 0.110 | 0.013 | 30.0 | 5.00% |
| Harcros 8810 | 100.0% | 0.8 | 0.002 | 0.000 | 0.5 | 0.08% |
| IND | | | | | | |
| Isopropylamine | 99.0% | 0.9 | 0.002 | 0.000 | 0.5 | 0.09% |
| Acticide B20 | 100.0% | 4.0 | 0.009 | 0.001 | 2.4 | 0.40% |
| DI Water | 100% | 836.9 | 1.843 | 0.221 | 502.1 | 83.69% |
| Totals | | 1000.0 | 2.203 | 0.260 | 600.0 | 100.00% |

| Label | Active Ingredient % | lbs/gal |
|---|---|---|
| Dichlobenil | 0.84% | 0.071 |
| Glyphosate | 0.74% | 0.062 |

| | |
|---|---|
| Theoretical Density = | 8.46 lbs/gal |
| pH = | {6.2-6.8} |

TABLE 3
Formulation 3: ready-to-use composition.

| | | | | | Prep | |
|---|---|---|---|---|---|---|
| | | Mass | Mass | Vol | Mass | Prep |
| Ingredient | Purity | (g) | (lb) | (gal) | (g) | Wt % |
| Casoron CS | 15.3% | 15.8 | 0.035 | 0.004 | 9.5 | 1.58% |
| Glyphosate IPA | 62.5% | 1.8 | 0.004 | 0.000 | 1.1 | 0.18% |
| Atlox 4913 | 100.0% | 3.00 | 0.007 | 0.001 | 1.8 | 0.30% |
| Tomadol 1-7 | 100.0% | 20.0 | 0.044 | 0.005 | 12.0 | 2.00% |
| Attagel 50 | 100.0% | 14.8 | 0.033 | 0.002 | 8.9 | 1.48% |
| Keltrol BT | 100.0% | 3.0 | 0.007 | 0.000 | 1.8 | 0.30% |
| Propylene Glycol | 100.0% | 48.5 | 0.107 | 0.012 | 29.1 | 4.85% |
| Harcros 8810 | 100.0% | 0.6 | 0.001 | 0.000 | 0.4 | 0.06% |
| IND | | | | | | |
| Citric Acid | 50.0% | 0.90 | 0.002 | 0.000 | 0.5 | 0.09% |
| Acticide B20 | 100.0% | 4.0 | 0.009 | 0.001 | 2.4 | 0.40% |
| DI Water | 100% | 887.6 | 1.955 | 0.235 | 532.6 | 88.76% |
| Totals | | 1000.0 | 2.203 | 0.262 | 600.0 | 100.00% |

| Label | Active Ingredient % | lbs/gal |
|---|---|---|
| Dichlobenil | 0.24% | 0.020 |
| Glyphosate | 0.11% | 0..009 |

| | |
|---|---|
| Theoretical Density = | 8.42 lbs/gal |
| pH = | {6.2-6.8} |

TABLE 4
Formulation 4: ready-to-use composition.

| | | | | | Prep | |
|---|---|---|---|---|---|---|
| | | Mass | Mass | Vol | Mass | Prep |
| Ingredient | Purity | (g) | (lb) | (gal) | (g) | Wt % |
| Casoron CS | 15.3% | 331.0 | 0.729 | 0.080 | 47.3 | 8.31% |
| Glyphosate IPA | 62.5% | 20.5 | 0.045 | 0.000 | 2.9 | 0.51% |
| Tomadol 1-7 | 100.0% | 80.0 | 0.176 | 0.010 | 11.4 | 2.01% |
| Atlox 4913 | 100.0% | 12.0 | 0.026 | 0.000 | 1.7 | 0.30% |
| Attagel 50 | 100.0% | 58.0 | 0.128 | 0.010 | 8.3 | 1.46% |
| Keltrol BT | 100.0% | 12.0 | 0.026 | 0.002 | 1.7 | 0.30% |
| Propylene Glycol | 100.0% | 192.0 | 0.423 | 0.049 | 27.4 | 4.81% |
| Dimethylamine | 44.0% | 4.0 | 0.009 | 0.001 | 0.6 | 0.10% |
| Proxel GXL | 100.0% | 16.0 | 0.035 | 0.004 | 2.3 | 0.40% |
| City Water | 100% | 3260.0 | 7.181 | 0.862 | 465.7 | 81.79% |
| Totals | | 3985.5 | 8.779 | 1.018 | 569.4 | 100.00% |

| Label | Active Ingredient % | lbs/gal |
|---|---|---|
| Dichlobenil | 1.27% | 0.110 |
| Glyphosate | 0.32% | 0.028 |

| | |
|---|---|
| Theoretical Density = | 8.62 lbs/gal |
| pH = | 7.20 |

TABLE 5
Formulation 5: concentrate composition.

| | | | | | Prep | |
|---|---|---|---|---|---|---|
| | | Mass | Mass | Vol | Mass | Prep |
| Ingredient | Purity | (g) | (lb) | (gal) | (g) | Wt % |
| Casoron CS | 15.3% | 1000.0 | 2.203 | 0.240 | 50.0 | 25.95% |
| Glyphosate IPA | 62.5% | 320.0 | 0.705 | 0.070 | 16.0 | 8.31% |
| Tomadol 1-7 | 100.0% | 75.0 | 0.165 | 0.010 | 3.8 | 1.95% |
| Attagel 50 | 100.0% | 58.0 | 0.128 | 0.010 | 2.9 | 1.51% |
| Keltrol BT | 100.0% | 12.0 | 0.026 | 0.002 | 0.6 | 0.31% |
| Propylene Glycol | 100.0% | 192.0 | 0.423 | 0.049 | 9.6 | 4.98% |
| NaOH | 5.0% | 280.0 | 0.617 | 0.073 | 14.0 | 7.27% |
| Proxel GXL | 100.0% | 16.0 | 0.035 | 0.004 | 0.8 | 0.42% |
| City Water | 100% | 1900.0 | 4.185 | 0.502 | 95.0 | 49.31% |
| Totals | | 3853.0 | 8.487 | 0.960 | 192.7 | 100.00% |

| Label | Active Ingredient % | lbs/gal |
|---|---|---|
| Dichlobenil | 3.97% | 0.351 |
| Glyphosate | 5.19% | 0.459 |

| | |
|---|---|
| Theoretical Density = | 8.84 lbs/gal |
| pH = | 5.50 |

TABLE 6
Formulation 6: concentrate composition.

| | | | | | Prep | |
|---|---|---|---|---|---|---|
| | | Mass | Mass | Vol | Mass | Prep |
| Ingredient | Purity | (g) | (lb) | (gal) | (g) | Wt % |
| Casoron 170CS | 15.0% | 133.5 | 0.294 | 0.032 | 66.8 | 13.35% |
| Glyphosate IPA | 62.5% | 41.5 | 0.091 | 0.010 | 20.8 | 4.15% |
| Tomadol 1-7 | 100.0% | 20.0 | 0.044 | 0.005 | 10.0 | 2.00% |
| Attagel 50 | 100.0% | 15.0 | 0.033 | 0.002 | 7.5 | 1.50% |
| Keltrol BT | 100.0% | 4.2 | 0.009 | 0.001 | 2.1 | 0.42% |
| Propylene Glycol | 100.0% | 50.0 | 0.110 | 0.013 | 25.0 | 5.00% |
| NaOH Sol'n | 5.0% | 26.8 | 0.059 | 0.007 | 31.0 | 6.20% |
| Acticide B20 | 100.0% | 4.0 | 0.009 | 0.001 | 2.0 | 0.40% |
| DI Water | 100% | 705.0 | 1.553 | 0.186 | 334.9 | 66.98% |
| Totals | | 1000.0 | 2.203 | 0.257 | 500.0 | 100.00% |

| Label | Active Ingredient % | lbs/gal |
|---|---|---|
| Dichlobenil | 2.00% | 0.172 |
| Glyphosate | 2.59% | 0.222 |

| | |
|---|---|
| Theoretical Density = | 8.57 lbs/gal |
| pH = | 6.60 |

### Example II

### Chemical Stability Testing

Formulations were prepared as described in Example I. Physically stable formulations (no settling or physical issues observed) were tested for chemical stability over various time spans and temperature conditions. The results are presented in the tables below.

TABLE 7
Formulation 1: Ambient One Year Stability

| | Initial | % Change From Initial Label Rate | | | |
|---|---|---|---|---|---|
| | Label | Three | Six | Nine | |
| Active Ingredient | Rate | Months | Months | Months | One Year |
| Dichlobenil | 7.58% | 3.00% | 2.70% | 3.10% | −2.20% |
| Glyphosate | 5.45% | −2.00% | −1.40% | −0.70% | 2.00% |

Note:
Allowable limits are +/−5% from initial values.
All time points were within this acceptable limit justifying chemical stability for one year ambient storage.

TABLE 8
Formulation 2: Ambient One Year Stability

| | Initial | % Change From Initial Label Rate | | | |
|---|---|---|---|---|---|
| | Label | Three | Six | Nine | |
| Active Ingredient | Rate | Months | Months | Months | One Year |
| Dichlobenil | 0.84% | −0.20% | −0.40% | −0.20% | 1.20% |
| Glyphosate | 0.74% | 4.70% | 0.00% | 1.40% | 4.90% |

Note:
Allowable limits are +/−10% from initial values.
All time points were within this acceptable limit justifying chemical stability for one year ambient storage.

TABLE 9
Formulation 3: Ambient One Year Stability

| | Initial | % Change From Initial Label Rate | | | |
|---|---|---|---|---|---|
| | Label | Three | Six | Nine | |
| Active Ingredient | Rate | Months | Months | Months | One Year |
| Dichlobenil | 0.24% | 2.30% | 5.50% | 3.10% | −0.40% |
| Glyphosate | 0.11% | 0.90% | 8.80% | 8.00% | −9.70% |

Note:
Allowable limits are +/−10% from initial values.
All time points were within this acceptable limit justifying chemical stability for one year ambient storage.

TABLE 10
Formulation 4: 40° C. Accelerated Stability

| | Initial Label | Compared to Label | |
|---|---|---|---|
| Active Ingredient | Rate | (Post-Oven) | Comments |
| Dichlobenil | 1.27% | −0.40% | Exposed to 32 |
| Glyphosate | 0.32% | −8.94% | Days of elevated |
| | | | temperature. |

TABLE 11
Formulation 5: 40° C. Accelerated Stability

| | Initial Label | Compared to Label | |
|---|---|---|---|
| Active Ingredient | Rate | (Post-Oven) | Comments |
| Dichlobenil | 3.97% | 1.09% | Exposed to 32 |
| Glyphosate | 5.19% | −1.36% | Days of elevated |
| | | | temperature. |

TABLE 12
Formulation 5: Ambient Stability

| | Initial Label | | |
|---|---|---|---|
| Active Ingredient | Rate | Compared to Label | Comments |
| Dichlobenil | 3.97% | 8.44% | Duration of the |
| Glyphosate | 5.19% | −2.73% | ambient storage |
| | | | was One year and |
| | | | seven months. |

TABLE 13
Formulation 5: Additional Testing

| | Test | |
|---|---|---|
| Physical Testing | Conditions | Comments |
| Three Freeze/Thaw | −15° C. for | Passed, no syneresis (bleed |
| Cycles | twelve hours, | layer formation) observed. |
| | then 25° C. for | |
| | twelve hours, | |
| | repeat for three | |
| | cycles | |
| Refrigeration | 5° C. for | Passed, no syneresis (bleed |
| | approximately | layer formation) observed. |
| | six months | |
| Extreme Cycling | −25° C. for | Passed, no syneresis¹ (bleed |
| | twelve hours, | layer formation) observed. |
| | then 40° C. for | |
| | twelve hours, | |
| | repeat for seven | |
| | cycles | |

¹Syneresis: the suspended solids begin to pull away from the surface of the liquid.

TABLE 14
Formulation 6: 40° C. Accelerated Stability

| | Initial Label | Compared to Label | |
|---|---|---|---|
| Active Ingredient | Rate | (Post-Oven) | Comments |
| Dichlobenil | 2.00% | 0.65% | Exposed to 32 |
| Glyphosate | 2.59% | −3.53% | Days of elevated |
| | | | temperature. |

TABLE 15
Formulation 6: Ambient Stability

| | Initial Label | | |
|---|---|---|---|
| Active Ingredient | Rate | Compared to Label | Comments |
| Dichlobenil | 2.00% | −0.23% | Duration of the |
| Glyphosate | 2.59% | −4.71% | ambient storage |
| | | | was 6.5 months. |

As shown in the tables above, formulations prepared in accordance with the present invention were storage stable under ambient conditions for up to at least one year, or even up to at least one year and seven months. Formulations also showed acceptable storage stability under extreme storage conditions, including periods of hot temperatures (e.g., 40° C.), refrigeration, freeze/thaw cycles, and extreme temperature cycling (e.g., cycling between 40° C. and −25° C.).

### Example III

Additional concentrate and ready-to-use compositions were prepared as provided in the tables below. The ready-to-use compositions do not need to be diluted with water prior to application to undesired vegetation.

TABLE 16
Formulation 7: concentrate composition.

| | | | | | Prep | |
|---|---|---|---|---|---|---|
| | | Mass | Mass | Vol | Mass | Prep |
| Ingredient | Purity | (g) | (lb) | (gal) | (g) | Wt % |
| Casoron CS | 15.3% | 690.0 | 1.520 | 0.170 | 34.50 | 17.72% |
| Glyphosate IPA | 62.5% | 221.0 | 0.487 | 0.050 | 11.05 | 5.68% |
| Tomadol 1-7 | 100.0% | 75.0 | 0.165 | 0.010 | 3.75 | 1.93% |
| Attagel 50 | 100.0% | 59.0 | 0.130 | 0.010 | 2.95 | 1.52% |
| Keltrol BT | 100.0% | 13.0 | 0.029 | 0.002 | 0.65 | 0.33% |
| Propylene Glycol | 100.0% | 195.0 | 0.430 | 0.026 | 9.75 | 5.01% |
| NaOH | 5.0% | 160.0 | 0.352 | 0.042 | 8.00 | 4.11% |
| Proxel GXL | 100.0% | 16.0 | 0.035 | 0.004 | 0.80 | 0.41% |
| City Water | 100% | 2465.0 | 5.430 | 0.652 | 123.25 | 63.30% |
| Totals | | 3894.0 | 8.577 | 0.966 | 194.70 | 100.00% |

| Label | Active Ingredient % | lbs/gal |
|---|---|---|
| Dichlobenil | 2.71% | 0.241 |
| Glyphosate | 3.55% | 0.315 |

| | |
|---|---|
| Theoretical Density = | 8.88 lbs/gal |
| pH = | 5.50 |

TABLE 17
Formulation 8: concentrate composition.

| | | | | | Prep | |
|---|---|---|---|---|---|---|
| | | Mass | Mass | Vol | Mass | Prep |
| Ingredient | Purity | (g) | (lb) | (gal) | (g) | Wt % |
| Casoron CS | 15.3% | 488.0 | 1.075 | 0.120 | 24.40 | 13.06% |
| Glyphosate IPA | 62.5% | 155.0 | 0.341 | 0.040 | 7.75 | 4.15% |
| Tomadol 1-7 | 100.0% | 75.0 | 0.165 | 0.010 | 3.75 | 2.01% |
| Attagel 50 | 100.0% | 56.0 | 0.123 | 0.010 | 2.80 | 1.50% |
| Keltrol BT | 100.0% | 13.0 | 0.029 | 0.002 | 0.65 | 0.35% |
| Propylene Glycol | 100.0% | 195.0 | 0.430 | 0.026 | 9.75 | 5.22% |
| NaOH | 5.0% | 100.0 | 0.220 | 0.026 | 5.00 | 2.68% |
| Proxel GXL | 100.0% | 16.0 | 0.035 | 0.004 | 0.80 | 0.43% |
| City Water | 100% | 2640.0 | 5.815 | 0.698 | 132.00 | 70.63% |
| Totals | | 3738.0 | 8.233 | 0.936 | 186.90 | 100.00% |

| Label | Active Ingredient % | lbs/gal |
|---|---|---|
| Dichlobenil | 2.00% | 0.176 |
| Glyphosate | 2.59% | 0.228 |

| | |
|---|---|
| Theoretical Density = | 8.80 lbs/gal |
| pH = | 5.50 |

### Example IV

### Vegetation Control Testing

All trials were at a research station having soil conditions that are a clay loam with good soil moisture.

### Trial 1

Treatments were applied using a CO₂ powered backpack spray, calibrated at 43.56 gallons/Acre (407.7 L/ha at 241.3 kPa). The experimental design was a randomized complete block, containing three replications, measuring 0.3 m×3.0 m. Plots were a mixed stand of tall fescue (Festuca arundinacea) and mixed broadleaf and grassy weeds. Table 18 contains total vegetation control data from trial initiation to 217 days after application, study conclusion. Data in table 18 indicates experimental formulations of glyphosate+dichlobenil, Formulations 5, 7, and 8. These formulations showed no statistical difference from the standard EH-1472 (a comparison ready-to-use herbicidal product by PBI Gordon), and showed and significant reduction in total vegetation compared to the untreated check. Total vegetation control was acceptable throughout the duration of the study, maintaining >87% control in all experimental treatments.

TABLE 18
Total vegetation control data from Trial 1.

| | | Rate | % Control (Days After Application) | | | | | |
|---|---|---|---|---|---|---|---|---|
| Treatment | Rate | Unit | 7 d | 14 d | 21 d | 29 d | 35 d | 217 d |
| Formulation 5 | | | 2.7bc | 61.7 | 92.7a | 98.7a | 99.8a | 87.8a |
| Liquid | 16 | fl oz/ | | | | | | |
| Casoron + | | 1000 ft² | | | | | | |
| Glyphosate | | | | | | | | |
| Dichlobenil | 1.9058 | lb ai/a | | | | | | |
| Glyphosate | 2.5047 | lb ai/a | | | | | | |
| Formulation 7 | | | 13.5abc | 80 | 90a | 96.7a | 99.1a | 95.2a |
| Liquid | 24 | fl oz/ | | | | | | |
| Casoron + | | 1000 ft² | | | | | | |
| Glyphosate | | | | | | | | |
| Dichlobenil | 1.9602 | lb ai/a | | | | | | |
| Glyphosate | 2.6136 | lb ai/a | | | | | | |
| Formulation 8 | | | 19ab | 73.3 | 93.3a | 96.7a | 99.8a | 97.0a |
| Liquid | 32 | fl oz/ | | | | | | |
| Casoron + | | 1000 ft² | | | | | | |
| Glyphosate | | | | | | | | |
| Dichlobenil | 1.9166 | lb ai/a | | | | | | |
| Glyphosate | 2.5047 | lb ai/a | | | | | | |
| Untreated | | | 0c | 0 | 0c | 5c | 10c | 0b |
| Check | | | | | | | | |
| EH-1472 | 106.7 | fl oz/ | 36a | 56.7 | 60b | 68.3b | 74.7b | 85.9a |
| RTU | | 1000 ft² | | | | | | |
| Imazapyr | 0.6536 | lb ai/a | | | | | | |
| Glyphosate | 1.3225 | lb ai/a | | | | | | |

Means followed by same letter or symbol do not significantly differ (P = .05, LSD).

### Trial 2

Treatments were applied using a CO₂ powered backpack spray, calibrated at 43.56 gallons/Acre (407.7 L/ha at 241.3 kPa). The experimental design was a randomized complete block, containing three replications, measuring 0.3 m×3.0 m. Plots were a mixed stand of tall fescue (Festuca arundinacea) and mixed broadleaf and grassy weeds. Table 19 contains total vegetation control data from trial initiation to 19 days after application, study conclusion. Data in table 19 indicates experimental formulations of glyphosate alone, dichlobenil alone, and the combination of glyphosate and dichlobenil from Formulation 8. These formulations showed no statistical difference from the standard glyphosate and significant reduction in total vegetation compared to dichlobenil and untreated check. Total vegetation control was acceptable throughout the duration of the study, maintaining 100% control in all experimental treatments.

TABLE 19
Total vegetation control data from Trial 2.

| | | | % Control (Days After Application) | | | | |
|---|---|---|---|---|---|---|---|
| Treatment | Rate | Rate Unit | 5 d | 7 d | 12 d | 15 d | 19 d |
| Formulation 8 | 32 | fl oz/1000 ft² | 5.2a | 12.7a | 66.7a | 90a | 100a |
| Dichlobenil | 1.9166 | lb ai/a | | | | | |
| Glyphosate | 2.5047 | lb ai/a | | | | | |
| Casoron 170 CS | 32 | fl oz/1000 ft² | 0.4b | 1b | 1b | 1b | 2.7b |
| Dichlobenil | 1.9058 | lb ai/a | | | | | |
| Glyphomate 41 | 6.5 | pt/a | 3.5a | 15a | 61.7a | 87.3a | 100a |
| Glyphosate | 3.0875 | lb ai/a | | | | | |
| Untreated Check | | | 0b | 0b | 0b | 0b | 2b |

Means followed by same letter or symbol do not significantly differ (P = .05, LSD).

### Trial 3

Treatments were applied using a CO₂ powered backpack spray, calibrated at 43.56 gallons/Acre (407.7 L/ha at 241.3 kPa). The experimental design was a randomized complete block, containing three replications, measuring 0.3 m×3.0 m. Plots were a mixed stand of tall fescue (Festuca arundinacea) and mixed broadleaf and grassy weeds. Table 20 contains total vegetation control data from trial initiation to 138 days after application, study conclusion. Data in table 20 indicates that two experimental formulations (A and B, having different ratios of active ingredients and being applied at different concentrations) showed no statistical difference from the standard Regan & Massey RM43™ herbicide product, and showed a significant reduction in total vegetation compared to the untreated check. Total vegetation control was >70% for the duration of the study.

TABLE 20
Total vegetation control data from Trial 3

| | | | % Control | | | | | |
|---|---|---|---|---|---|---|---|---|
| | | Rate | (Days After Application) | | | | % Cover (DAA) | |
| Treatment | Rate | Unit | 3 d | 7 d | 14 d | 20 d | 59 d | 138 d |
| Formulation A | 995 | pt/a | 12.6a | 50a | 89.4b | 98a | 16.3bc | 71.7b |
| Glyphosate | 11.94 | lb ai/a | | | | | | |
| Dichlobenil | 9.2038 | lb ai/a | | | | | | |
| Formulation B | 3484 | pt/a | 19.8a | 53.3a | 79.5b | 87.3b | 28.3b | 75b |
| Glyphosate | 4.0688 | lb ai/a | | | | | | |
| Dichlobenil | 9.1875 | lb ai/a | | | | | | |
| Untreated Check | | | 0b | 0b | 0c | 0c | 100a | 100a |
| Regan Massey | 20.1 | pt/a | 11.5a | 56.7a | 99a | 99.6a | 5.5c | 60b |
| RM43 | | | | | | | | |
| Glyphosate | 7.9 | lb ai/a | | | | | | |
| Imazapyr | 0.156 | lb ai/a | | | | | | |

Means followed by same letter or symbol do not significantly differ (P = .05, LSD).

### Example V

Additional concentrate and ready-to-use compositions were prepared as provided in the tables below. The ready-to-use compositions do not need to be diluted with water prior to application to undesired vegetation.

TABLE 21
Formulation 9 (similar to Formulation 4, using different
dichlobenil product): ready-to-use composition.

| | | | | | Prep | |
|---|---|---|---|---|---|---|
| | | Mass | Mass | Vol | Mass | Prep |
| Ingredient | Purity | (g) | (lb) | (gal) | (g) | Wt % |
| Casoron 170CS | 15.0% | 331.0 | 0.729 | 0.079 | 198.6 | 8.31% |
| Glyphosate IPA | 62.5% | 20.5 | 0.045 | 0.005 | 12.3 | 0.51% |
| Tomadol 1-7 | 100.0% | 80.0 | 0.176 | 0.021 | 48.0 | 2.01% |
| Atlox 4913 | 100.0% | 12.0 | 0.026 | 0.003 | 7.2 | 0.30% |
| Attagel 50 | 100.0% | 58.0 | 0.128 | 0.010 | 34.8 | 1.46% |
| Keltrol BT | 100.0% | 12.0 | 0.026 | 0.002 | 7.2 | 0.30% |
| Propylene Glycol | 100.0% | 192.0 | 0.423 | 0.049 | 115.2 | 4.82% |
| Dimethylamine | 44.0% | 4.0 | 0.009 | 0.001 | 2.4 | 0.10% |
| Acticide B20 | 100.0% | 16.0 | 0.035 | 0.004 | 9.6 | 0.40% |
| DI Water | 100% | 3260.0 | 7.181 | 0.862 | 1956.0 | 81.80% |
| Totals | | 3985.5 | 8.779 | 1.035 | 2391.3 | 100.00% |

| Label | Active Ingredient % | lbs/gal |
|---|---|---|
| Dichlobenil | 1.25% | 0.106 |
| Glyphosate | 0.32% | 0.027 |

| | |
|---|---|
| Theoretical Density = | 8.48 lbs/gal |
| pH = | 6.60 |

TABLE 22
Formulation 10: concentrate composition.

| | | | | | Prep | |
|---|---|---|---|---|---|---|
| | | Mass | Mass | Vol | Mass | Prep |
| Ingredient | Purity | (g) | (lb) | (gal) | (g) | Wt % |
| Casoron CS | 15.3% | 1426.0 | 3.141 | 0.340 | 285.2 | 49.58% |
| Glyphosate IPA | 62.5% | 50.0 | 0.110 | 0.010 | 10.0 | 1.74% |
| Tomadol 1-7 | 100.0% | 60.0 | 0.132 | 0.010 | 12.0 | 2.09% |
| Atlox 4913 | 100.0% | 45.0 | 0.099 | 0.010 | 9.0 | 1.56% |
| Attagel 50 | 100.0% | 58.0 | 0.128 | 0.010 | 11.6 | 2.02% |
| Keltrol BT | 100.0% | 9.0 | 0.020 | 0.001 | 1.8 | 0.31% |
| Propylene Glycol | 100.0% | 150.0 | 0.330 | 0.038 | 30.0 | 5.22% |
| Dimethylamine | 44.0% | 16.0 | 0.035 | 0.004 | 3.2 | 0.56% |
| Proxel GXL | 100.0% | 12.0 | 0.026 | 0.003 | 2.4 | 0.42% |
| City Water | 100% | 1050.0 | 2.313 | 0.278 | 210.0 | 36.51% |
| Totals | | 2876.0 | 6.335 | 0.704 | 575.2 | 100.00% |

| Label | Active Ingredient % | lbs/gal |
|---|---|---|
| Dichlobenil | 7.59% | 0.682 |
| Glyphosate | 1.09% | 0.098 |

| | |
|---|---|
| Theoretical Density = | 8.99 lbs/gal |
| pH = | 6.60 |

TABLE 23
Formulation 11: concentrate composition.

| | | | | | Prep | |
|---|---|---|---|---|---|---|
| | | Mass | Mass | Vol | Mass | Prep |
| Ingredient | Purity | (g) | (lb) | (gal) | (g) | Wt % |
| Casoron 170CS | 15.0% | 264.8 | 0.583 | 0.063 | 158.9 | 26.48% |
| Glyphosate IPA | 62.5% | 83.1 | 0.183 | 0.019 | 49.9 | 8.31% |
| Tomadol 1-7 | 100.0% | 19.5 | 0.043 | 0.005 | 11.7 | 1.95% |
| Attagel 50 | 100.0% | 15.1 | 0.033 | 0.002 | 9.1 | 1.51% |
| Keltrol BT | 100.0% | 4.2 | 0.009 | 0.001 | 2.1 | 0.35% |
| Propylene Glycol | 100.0% | 50.0 | 0.110 | 0.013 | 30.0 | 5.00% |
| NaOH | 5.0% | 72.7 | 0.160 | 0.019 | 87.2 | 14.53% |
| Acticide B20 | 100.0% | 4.0 | 0.009 | 0.001 | 2.4 | 0.40% |
| DI Water | 100% | 486.6 | 1.072 | 0.129 | 248.8 | 41.47% |
| Totals | | 1000.0 | 2.203 | 0.252 | 600.0 | 100.00% |

| Label | Active Ingredient % | lbs/gal |
|---|---|---|
| Dichlobenil | 3.97% | 0.347 |
| Glyphosate | 5.19% | 0.454 |

| | |
|---|---|
| Theoretical Density = | 8.74 lbs/gal |
| pH = | 6.60 |

TABLE 24
Formulation 12: concentrate composition.

| | | | | | Prep | |
|---|---|---|---|---|---|---|
| | | Mass | Mass | Vol | Mass | Prep |
| Ingredient | Purity | (g) | (lb) | (gal) | (g) | Wt % |
| *Casoron ® | 15.0% | 181.0 | 0.399 | 0.043 | 90.5 | 17.77% |
| 170CS | | | | | | |
| Glyphosate IPA | 62.5% | 57.0 | 0.126 | 0.013 | 28.5 | 5.60% |
| Tomadol 1-7 | 100.0% | 19.5 | 0.043 | 0.005 | 9.8 | 1.91% |
| Attagel 50 | 100.0% | 15.2 | 0.033 | 0.003 | 7.6 | 1.49% |
| Keltrol BT | 100.0% | 4.2 | 0.009 | 0.001 | 2.1 | 0.41% |
| Propylene Glycol | 100.0% | 50.0 | 0.110 | 0.013 | 25.0 | 4.91% |
| NaOH Sol'n | 5.0% | 41.1 | 0.091 | 0.011 | 45.5 | 8.94% |
| Acticide B20 | 100.0% | 4.0 | 0.009 | 0.001 | 2.0 | 0.39% |
| DI Water | 100% | 628.0 | 1.383 | 0.166 | 298.2 | 58.57% |
| Totals | | 1000.0 | 2.203 | 0.255 | 509.2 | 100.00% |

| Label | Active Ingredient % | lbs/gal |
|---|---|---|
| Dichlobenil | 2.72% | 0.235 |
| Glyphosate | 3.56% | 0.307 |

| | |
|---|---|
| Theoretical Density = | 8.63 lbs/gal |
| pH = | 6.60 |

### Example VI

This example shows a large-scale formulation of an herbicidal composition concentrate in accordance with one embodiment of the present invention.

TABLE 25
Formulation 13: large-scale formulation.

| Ingredients | Purity | Prep Mass (lbs) | Prep Wt % |
|---|---|---|---|
| Casoron CS | 15.3% | 231.94 | 25.95% |
| Glyphosate IPA | 62.0% | 74.87 | 8.38% |
| DI Water | 100% | 483.20 | 54.06% |
| Propylene Glycol | 100.0% | 44.51 | 4.98% |
| Tomadol 1-7 | 100.0% | 17.43 | 1.95% |
| Harcros 8810 | 100% | 9.92 | 1.11% |
| IND | | | |
| Attagel 50 | 100.0% | 6.75 | 0.76% |
| Keltrol BT | 100.0% | 1.88 | 0.21% |
| Acticide B20 | 100.0% | 3.75 | 0.42% |
| KOH | 45.0% | 19.55 | 2.19% |
| Totals | | 893.80 | 100.00% |

| Label | Active Ingredient % | lbs/gal |
|---|---|---|
| Dichlobenil | 5.19% | 0.458 |
| Glyphosate | 3.97% | 0.350 |

| | |
|---|---|
| Theoretical Density = | 8.819 lbs/gal |
| pH = | 6.50 |

In the large-scale formulation shown above, the particle size distribution for the encapsulated dichlobenil ranged from 0.2μ to 128μ. The particle sizes were measured and collected using a Horiba LA-950 Laser Scattering Particle Size Distribution Analyzer. The samples were placed directly into the instrument to obtain the particle distribution. Additionally, the viscosity of the formulation was measured as follows: 60 RPM=230 cps; 30 RPM=354 cps; 12 RPM=642 cps.

1. An aqueous herbicidal concentrate composition comprising glyphosate, dichlobenil, and a nonionic surfactant dispersed in water.

2. The composition of claim 1, wherein said dichlobenil is encapsulated in a polymer membrane and/or resinous coating.

3. The composition of claim 1, said composition being substantially free of cationic and anionic surfactants.

4. The composition of claim 1, wherein said glyphosate comprises a sodium, potassium, dimethyl amine, ammonium or alkylamine salt of glyphosate.

5. The composition of claim 1, wherein said nonionic surfactant comprises a polymer selected from the group consisting of acrylic copolymers, block copolymers, comb polymers, star-shaped polymers, ethoxylated alcohols, polymethyl methacrylate-polyethylene glycol graft copolymers, and mixtures thereof.

6. The composition of claim 1, wherein the weight ratio of said nonionic surfactant to said dichlobenil is from about 1:5 to about 5:1.

7. The composition of claim 1, said composition being storage stable for at least 3 months at 25° C.

8. An herbicidal use solution comprising one part by weight of the concentrate according to claim 1 diluted in about 8 to about 30 parts by weight of water.

9. An aqueous ready-to-use herbicidal composition comprising glyphosate, dichlobenil, and a nonionic surfactant dispersed in water, wherein said composition is formulated for application to vegetation without being further diluted.

10. The composition of claim 9, wherein said dichlobenil is encapsulated in a polymer membrane and/or resinous coating.

11. The composition of claim 9, said composition being substantially free of cationic and anionic surfactants.

12. The composition of claim 9, wherein said glyphosate comprises a sodium, potassium, dimethyl amine, ammonium or alkylamine salt of glyphosate.

13. The composition of claim 9, wherein said nonionic surfactant comprises a polymer selected from the group consisting of acrylic copolymers, block copolymers, comb polymers, star-shaped polymers, ethoxylated alcohols, polymethyl methacrylate-polyethylene glycol graft copolymers, and mixtures thereof.

14. The composition of claim 9, wherein the weight ratio of said nonionic surfactant to said dichlobenil is from about 1:2 to about 20:1.

15. The composition of claim 9, said composition being storage stable for at least 3 months at 25° C.

16. A method of controlling undesired vegetation comprising applying to the locus of the undesired vegetation, an herbicidally effective amount of an aqueous herbicidal composition comprising glyphosate, dichlobenil, and a nonionic surfactant dispersed in water.

17. The method of claim 16, wherein said dichlobenil is encapsulated in a polymer membrane and/or resinous coating.

18. The method of claim 16, said composition being substantially free of cationic and anionic surfactants.

19. The method of claim 16, wherein said glyphosate comprises a sodium, potassium, dimethyl amine, ammonium or alkylamine salt of glyphosate.

20. The method of claim 16, wherein said nonionic surfactant comprises a polymer selected from the group consisting of acrylic copolymers, block copolymers, comb polymers, star-shaped polymers, ethoxylated alcohols, polymethyl methacrylate-polyethylene glycol graft copolymers, and mixtures thereof.

21. The method of claim 16, wherein said aqueous herbicidal composition is initially provided as a concentrate, said method further comprising the step of diluting said composition with water to form a use solution prior to applying said composition to the locus of the undesired vegetation.

22. The method of claim 21, wherein the weight ratio of said nonionic surfactant to said dichlobenil is from about 1:5 to about 5:1.

23. The method of claim 16, wherein said composition is in the form of a read-to-use herbicide and is applied to the locus of the undesired vegetation without being diluted with water.

24. The method of claim 16, wherein said aqueous herbicidal composition is applied to the locus of the undesired vegetation at an amount sufficient to supply from about 0.01 to about 0.5 pounds per acre of said glyphosate and from about 0.01 to about 0.5 pounds per acre of said dichlobenil.

25. The method of claim 16, wherein said method achieves at least about 80% vegetation control after 14 days.
